(19) United States
(12) Patent Application Publication
(10) Pub. No.: US 2003/0197093 A1
(43) Pub. Date: Oct. 23, 2003

(54) Magnetic vortex wormhole generator

(76) Inventor: John Quincy St.Clair, San Juan, PR (US)

Correspondence Address: John St.Clair, Hyperspace Research Institute, 52 Kings Court, 4A, San Juan, PR, 00911, US

(21) Appl. No.: 10/127,098

(22) Filed: Apr. 20, 2002

(51) Int. Cl. B64C 27/00; B64C 39/00

(52) U.S. Cl. 244/62

(57) ABSTRACT

This invention relates to a magnetic vortex generator which has the ability to generate negative mass and a negative spring constant which, according to Einstein's General Theory of Relativity, is required in order to create a stable wormhole between our space and hyperspace. Two separate, but electrically connected, toroidal coils of differing radii, carry magnetic flux in opposite directions about their common centerline. According to Maxwell's equation, this produces bucking electric fields along said centerline. Because the two solenoids have different radii, the parallel spring constant of both coils is negative. The negative mass together with the negative spring constant produce a real resonant frequency which can distort the spacetime curvature due to the creation of powerful spikes of negative mass. This phenomenon, similar to the common electrical thunderstorm, opens up a wormhole into hyperspace through which low-density hyperspace energy can enter into our dimension. This energy finds many application in new types of power supplies, inertia-less and mass-less spacecraft, vehicles that can travel light-years by moving out of dimension through hyperspace, surgery-less medical tables, cranes for lifting heavy objects, cold-welded crystals for crystal rotors, folding space waveguides, and electromagnetic field propulsion vehicles using highly relativistic fields.

### BRIEF SUMMARY OF THE INVENTION

This invention, which is the subject of my present application, is comprised of two solenoids wound with a common wire in opposite directions on two separate toroidal curved-sheet transformer laminates of differing radii. The smaller solenoid is mounted along the centerline of the larger solenoid. This circular magnetic geometry creates linear bucking electric fields along the centerline of the coils. Because the magnetic flux in the laminates travels in opposite directions along arcs of differing radii in the two coils, a negative mass and a negative spring constant are generated by the system. From the theory of gravitational physics, a negative mass is prerequisite to producing a wormhole because it allows the throat of the wormhole to remain open and stable. The creation of the wormhole is facilitated by the appearance of a negative spring constant which allows the spacetime curvature to resonate to such a degree that said wormhole develops between our dimension and another co-dimension of hyperspace. Because the physics constants of hyperspace are different from ours, the wormhole allows hyperspace energy having a low speed of light to enter our dimension. Because electromagnetic fields obey the Lorentz transformation, it is now possible with this lower velocity of light to create huge relativistic fields which can drive the new electromagnetic field propulsion vehicles.

### BACKGROUND OF THE INVENTION

The idea for this coil configuration comes from the observation of powerful thunderstorms, as described by physicist Dr. Richard Feynman in his Lectures on Physics, a copy of which is enclosed as a reference. Upon reading his explanation, I realized that the thunderstorm is actually a hyperspace physics phenomenon.

After the passage of a large lightning storm, people have observed that a car tire rim has merged with the trunk of a tree growing in the ground. Due to the large branches of the tree, there is no possible way that it could slide down the branches and around the trunk. It was observed also that a straw of wheat became embedded in the hard wood of a telephone pole. It turns out that the thunderstorm offers an explanation as to how this can occur.

After reading Feynman's explanation, it can be seen that the key to this phenomenon is that there is a downward and an upward lightning bolt, sometimes occurring together if the leader branches into two paths. Bolts of lightning also like to strike tall objects such as telephone poles or trees. Now an electrical current moving downward produces a clockwise magnetic B field, as seen from above. On the return stroke, the current is moving upward which produces a counterclockwise magnetic B field. Thus the thunderstorm produces two huge bucking magnetic B fields which is the magnetic geometry of this magnetic vortex generator. Using my tetrahedron diagram, I will then show that the low density hyperspace energy with its low speed of light is able to pull the rim out of dimension so that it can merge with the tree at the moment the lightning strikes.

### SUMMARY OF THE INVENTION

It is the object of this invention to produce two toroidal oppositely-directed magnetic flux fields in two separate yet electrically connected solenoids of differing radii. Because the lines of flux are traveling in toroidal, curved-sheet transformer laminates along arcs of different curvature, the fields produce what is known in gravitational physics as negative mass. Negative mass has the property that if you project it onto a hot surface, the surface will cool rather than heat up. The negative mass, together with the resonance of the spacetime curvature involving a negative spring constant, create a wormhole into hyperspace. This interdimensional connection allows low speed of light hyperspace energy into our dimension which can be used to decrease the weight of an object, or produce huge relativistic electromagnetic fields that can be used to drive the new electromagnetic field propulsion spacecraft.

### STATEMENT REGARDING FEDERALLY SPONSORED RESEARCH OR DEVELOPMENT

Not Applicable.

### A BRIEF DESCRIPTION OF THE DRAWINGS

FIG. 1. Front view of magnetic vortex generator.

FIG. 2. Perspective view of the magnetic vortex generator.

FIG. 3. The non-linear coil winding on the interior face of the laminations.

FIG. 4. The non-linear coil winding on the exterior face of the laminations showing that there is an electrical current component in the theta direction.

FIG. 5. The coil variables for the tensor calculation of the negative spring constant.

FIG. 6. The Faraday electromagnetic tensor showing the position of the magnetic field in the {r,z} slots.

FIG. 7. The units of the spring constant.

FIG. 8. The parallel spacetime spring constant.

FIG. 9. The cylindrical g metric tensor including the magnetic fields.

FIG. 10. A plot of the mass term Gₙ for Einstein's G curvature tensor showing that two negative mass spikes are created along the centerline of the generator. Negative mass is required to keep open the throat of the wormhole.

FIG. 11. Circuit diagram for the magnetic vortex generator.

FIG. 12. BH curve for non-linear SuperMalloy toroidal core. From the equation, B=μH, the slope of the line is equal to the permeability ∂B/∂H=μ.

### DETAILED DESCRIPTION OF THE INVENTION

1. The fact that negative mass is required to keep the throat of a wormhole open has been shown to be valid by physicist Dr. Kip Thorne in the enclosed reference physics paper. The key point of this invention is that if you have a negative mass, you also require a negative spring constant in order to get a real frequency and vice versa. The angular frequency of vibration is equal to the square root of the spring constant K divided by the mass M, or ω=\sqrt{K/M}. If the mass is negative, and the spring constant is positive, the frequency is imaginary. Therefore, in order to get a real frequency, the spring constant has to be negative also.

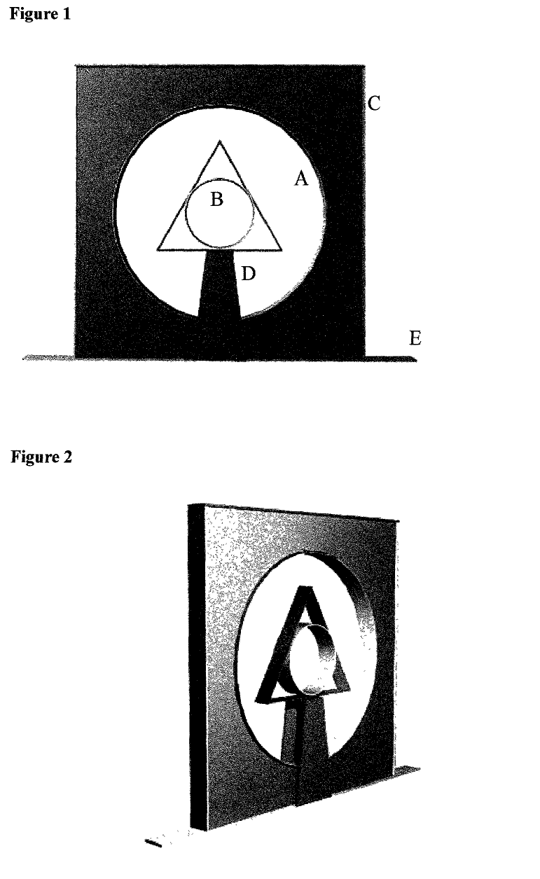

2. Referring to FIG. 1, the magnetic vortex generator consists of a large toroidal solenoid (A) and its support structure (C), a smaller toroidal coil (B) with its support structure (D) which holds the coil along the centerline of the larger coil. The entire structure sits on a base (E).

3. The two solenoids are wound with a common wire in opposite directions on two separate toroidal curved-sheet transformer laminations of differing radii. From the right hand rule, a changing circular magnetic field in the direction of the fingers produces a linear electric field in the direction of the thumb. Because there are two coils producing two magnetic fields in opposite directions, there are two bucking electric fields down the centerline of the coils. This duplicates the thunderstorm conditions. A perspective view of the generator is shown in FIG. 2.

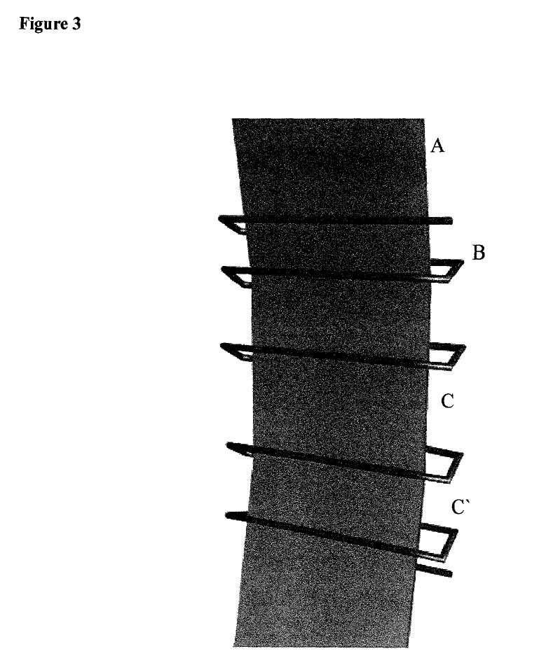

4. A enlarged view of the non-linear coil winding is shown in FIG. 3. The wire (B) is wound around the thin transformer laminations (A) with a non-linear coil spacing as shown by the difference in spacing between length (C) and (C′). On this inner side of the coil, the wire is wound straight across where it can be seen that the wire is normal to the edge of the laminations. Not shown are two strips of Velcro which keep the wire aligned and offset from the tape-covered metal laminations.

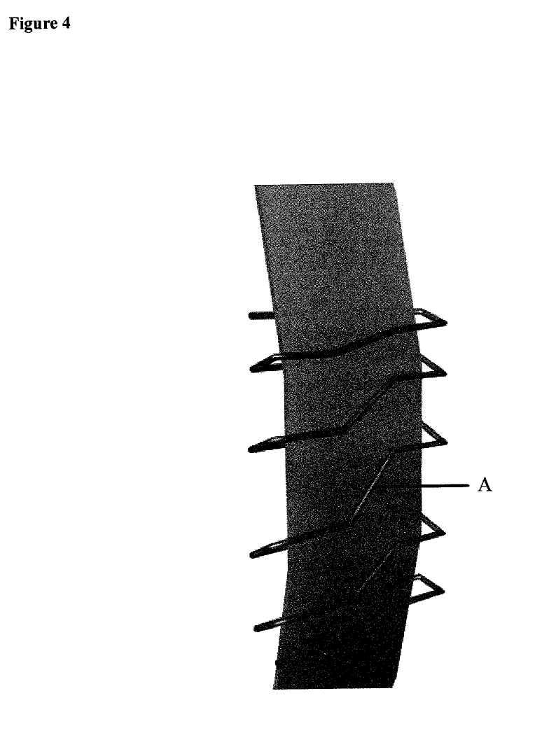

5. Since the wire is straight across on this side, the opposite side has to have the wire run in a diagonal manner as seen in FIG. 4A. In terms of cylindrical coordinates, the components of the electrical current in the coil flow in the z-direction across the breadth of the lamination and in the O-direction around the lamination.

6. The reason for the non-linear spacing is to preserve the vector potential of the coil. The vector potential is a more important field than the magnetic field because it can extend out past the windings of a long solenoid. If you look at the units, it is the field momentum per charge or kilogram meter per second coulomb. Notice that the derivative of the vector potential with respect to time is an electric field, while a derivative with respect to length is the magnetic field. The inductance of the coil times the current density is equal to the vector potential. Thus the inductance gradient of the coil times the current per meter is the magnetic field. So the non-linear coil picks up an additional magnetic field around the coil besides the one created in the laminations by the winding itself

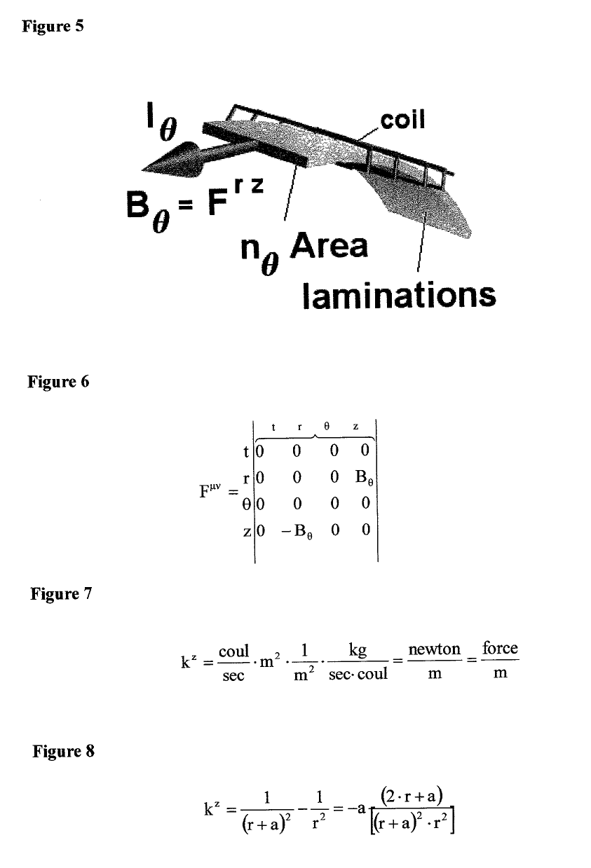

7. Taking a closer look at the coil in FIG. 5, it is constructed of thin laminations taped together to form a cylindrical shape with a wire coil wrapped around it. This creates a magnetic field in the theta θ direction within the laminations. Because the coil is wrapped as a helix, there is a current component I_{θ} in the theta direction. The cross-sectional area Area through which the magnetic flux flows times a normal vector n in the theta direction is the tensor area n_{θ} Area. If the radius of the coil is r, then the curvature K is 1/r² pointing in the radial direction. Because there are two coils with differing radii, the generator has two curvatures associated with it.

8. In the geometry of electromagnetism, the magnetic field is part of the electromagnetic Faraday tensor F^{μv} which is a 4 by 4 spacetime matrix having rows and columns of time t, radius r, angle θ and height z in cylindrical coordinates. The first index μ refers to the row, and the second index v refers to the column. The diagonal of the matrix is zero. The first row and column belong to the electric field. All the other slots are filled by the components of the magnetic field. The B_{θ} component is located in the complementary slots of r and z as shown in FIG. 6. Now a tensor product can be written with the available variables I^{θ} no Area KᵣF^{rz}=k^{z}. This says that the current around the loop in the theta direction times the lamination area vector in the theta direction times the curvature K of the coil in the radial direction times the magnetic field in the theta direction is equal to a spring constant in the z-direction, or normal to the plane of the coil. All the tensor components cancel out except for the z-direction. That is, the coil produces a spacetime spring constant through the center of the coil where there are resonant bucking electric fields. So the coil is creating a magnetic spring. The units of the spring constant are shown in FIG. 7 as force per meter.

9. Because there are two coils operating in opposite directions in regions of differing curvature, there are two parallel spring constants generated along the centerline. Two springs in parallel sum, but the inner coil is negative due to the triple product of negative signs of current, field and area. Looking at the front view of the coils, the right hand rule shows the field going counterclockwise with the thumb pointing along the electric field in the positive z-direction. The inner coil with the field going in the clockwise direction has the electric field in the negative z-direction. Therefore the outer coil's positive spring constant sums with the inner coil's negative spring constant to produce an overall negative spring constant as shown in FIG. 8. The inner coil has a radius r, and the spacing between the outer and inner coil is a. In this design, the inner radius is 1, and the outer radius is 3 which is the magic ratio in physics of 1/3. That makes length a equal to 2. Substituting r=1 and a=2 into the spring constant equation shows that the ratio is negative 8/9. That is, the spring constant is negative as previously asserted. If the spring constant is negative, it must produce negative mass in order to have a real frequency of resonance. Since it produces negative mass, then it can produce a wormhole as shown by Dr. Kip Thorne.

10. The geometry of hyperspace physics is based on the geometry of the tetrahedron which is circumscribed by the sphere. The corners of the tetrahedron touch the sphere at a latitude of 19.47122063° which turns out to be, in terms of planet cosmology, the location where all the large volcanoes and vortices occur on Earth, Mars, Jupiter, Uranus and Neptune. Furthermore, the cosine squared of this angle is 8/9, which is the spring constant ratio for the magnetic vortex generator. That is, the coil is interacting with the geometry of spacetime which is why it is such an effective wormhole generator. As will be demonstrated later, the tetrahedral geometry of hyperspace shows that the electron and proton are one and the same particle. This is a new discovery in science coming out of this research. The diagram also shows that when the speed of light is reduced, due to the low density of energy coming into our dimension through the wormhole, Planck's constant divided by the speed of light puts the electron at the boundary between space and hyperspace. That is, the electron and the proton go out of dimension which is the reason that the car tire rim can become merged with the tree. The ramifications of this magnetic vortex generator are enormous. It means developing new types of crystals through interdimensional merging which will be needed in the development of these spacecraft and their crystal rotors. It means the possibility of teleporting spacecraft through hyperspace over distances of light years using the new folding space waveguides. It means light-weight or inertia-less spacecraft which can be accelerated at hundreds of thousands of g's. It means the ability to lift extraordinary loads in construction work. It means surgery-less medical tables where tumors can be pulled directly out of the patient's body.

11. Because we have a magnetic spring, then there is some resonant frequency at which the coil can be operated in order to create a large spacetime distortion. It is this distortion that creates the wormhole into hyperspace. From this it follows that the wormhole attaches to a low pressure region with a magnetic monopole. Because pressure is linear mass times the speed of light squared divided by area, a low pressure signifies a low speed of light and less dense matter. What this means is that opposite polarity spacetime curvature at two ends of an electrode will produce a voltage along the electrode, effectively creating a power supply. The reason for this is that spacetime curvature, as shown by Einstein's General Theory of Relativity equation G_{αβ}=8πT_{αβ}, is equal to the square of the electromagnetic fields in the stress-energy tensor T. So the curvature on the ends of the electrode appear as voltages and the system acts as a battery supply to power the spacecraft.

12. The other characteristic of the magnetic vortex generator is that it can pull objects out of dimension allowing the object to apparently move through solid walls. The object doesn't actually move through the wall because the object is not in the same dimension as the wall; it just appears that way. Moving out of dimension and then back again on the other side of the wall would effectively move the object through the wall for all intents and purposes.

13. The tetrahedron diagram is a physics diagram which plots the natural logarithm of mass to the natural logarithm of wavelength. The product of mass times wavelength is equal to Planck's constant divided by the speed of light. So the product of the electron mass times its wavelength is equal to the proton mass times its wavelength is equal to the Planck mass times the Planck wavelength. The Planck wavelength is the bottom dimensional limit of the universe. We live in the Planck box which is bounded by the Planck wavelength and Planck mass. Outside this box is hyperspace.

14. Because logarithms sum, the sum of the log of the mass plus the log of the wavelength is a constant sum. Thus the electron and proton and Planck mass slide on a 45° line known as the base constant which is equal at the axes to the log of Planck's constant divided by the speed of light. Planck's constant is measured in joule-sec so that multiplying it by the frequency 1/second of light gives the energy of the photon particle.

15. Planck's constant is equal to the Planck wavelength times the Planck mass times the speed of light. The 45° base constant is Planck's constant divided by the speed of light, which means that the speed of light cancels out top and bottom, leaving the area of the Planck box as the value of the base constant. Hyperspace has a low linear mass compared to our dimension. Therefore, Planck's constant is reduced when this energy enters our dimension through the wormhole created by the generator. And the base constant is also so reduced. In terms of logs, this means that the 45° base line becomes more negative and moves to the right on the diagram. As it does so, the base line intersects the electron at the Planck wavelength which is the separation point between space and hyperspace. That is, the electron moves out of dimension. Because the electron and proton are one and the same particle, as shown in reference tetrahedron diagram tet0565, the proton and hence the entire atom is taken out of dimension as well.

16. All of this can be seen more easily graphically on the tetrahedron diagram itself, referring to reference tetrahedron diagram tet3025. The 45° line which intersects the electron at point (b) is the base constant for our dimension. As you can see, this base line intersects the horizontal axis at a value of −95.91546344 which is the log of Planck's constant h divided by the speed of light. Because Planck's constant is proportional to the linear mass, it is reduced in value by the low density hyperspace energy and, in terms of logs, becomes more negative. This moves the base line to the right at a value of around minus 105. The new base line intersects the electron at point (a) which is located on the Planck wavelength that is the boundary between space and hyperspace. Thus the electron at point (a) goes out of dimension.

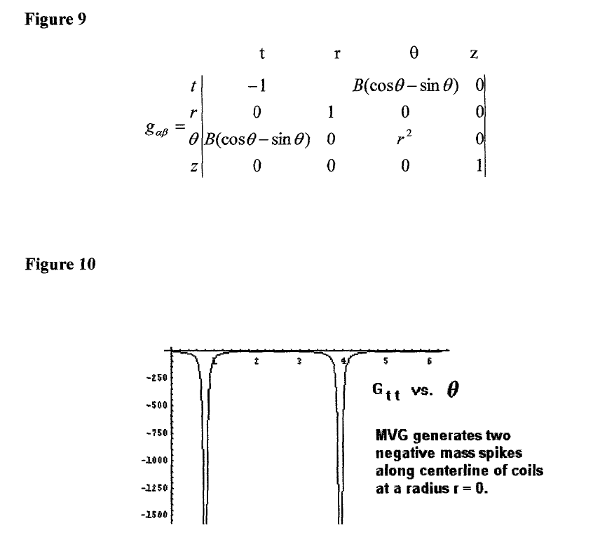

17. It was inferred previously that a negative spring constant meant a negative mass was produced by the wormhole generator. This can actually be calculated using Einstein's General Theory of Relativity. The calculation starts with the g metric tensor which is a spacetime measurement of distance in terms of time t, radius r, horizontal angle θ and length z. This 4 by 4 matrix is shown in FIG. 9 where the diagonal line has a signature in cylindrical coordinates of values equal to {−1, 1, r², 1}. All the other terms of the matrix are zero except for the magnetic fields in the two coils. Because the field is changing sinusoidally with time in the theta direction, the field has to go into the {t, θ} and {θ, t} slots of the matrix. Because the field in the inner coil is in the negative direction compared to the outer coil, and including a 90° phase shift between the two fields, a suitable magnetic field function would be B (cos(θ)-sin(θ)).

18. Using a general relativity software package, Einstein's G curvature tensor can be calculated for this particular metric. The first term G t in the upper left hand slot in the corner is the mass term for the tensor. All the other terms are either electromagnetic fluxes or pressure terms involving the squares of the fields.

19. Referring to FIG. 10, a plot of the mass as a function around a small circle shows that two negative mass spikes occur around the circumference of the circle. Because the radius is almost zero, the two spikes are actually coincident.

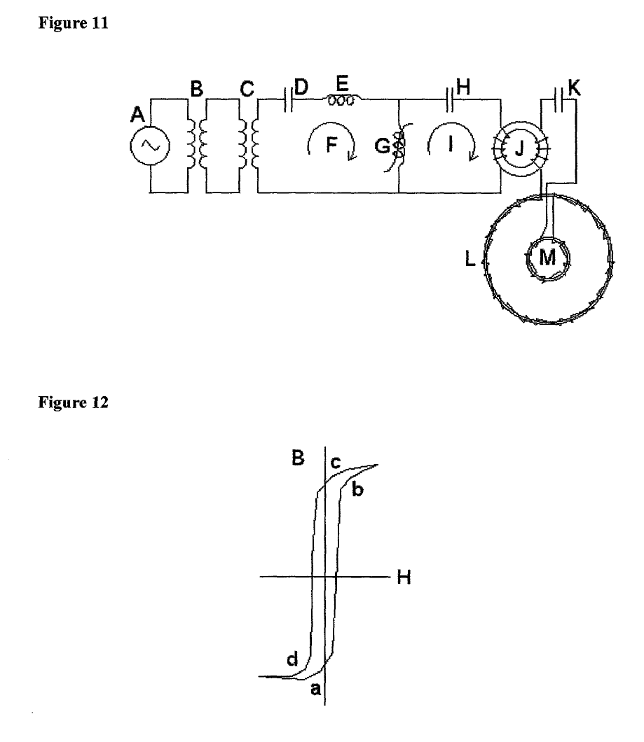

20. This next section shows the electrical system used to drive the magnetic vortex generator. Referring to FIG. 11, the system is driven by a sinusoidal voltage source (A) into a 1:1 turns isolation transformer (B). The voltage is stepped up into the range of thousands of volts using a step-up hi-pot transformer (C). The first loop consists of a direct current blocking capacitor (D), a transformer choke (E), a variable inductance (G) and the current in the loop (F). The variable inductance is a coil winding on a toroidal core wound with thousandth-inch thick SuperMalloy tape. This coil acts as a magnetic switch due to its variable permeability.

21. Referring to the accompanying drawing in FIG. 12, the slope of the BH curve is actually the permeability of the core. At point (a) on the curve, the slope is very low and therefore the permeability is very small. The resistance of the coil is the frequency of the current times the inductance of the coil. If the permeability is small, then the inductance is low, which means that the coil resistance is low initially. With a low resistance in the coil, current (F) flows through the winding rather easily. Then the coil goes from point (a) to point (b) where the permeability and resistance increase. This change in resistance from a low to a high value dumps the magnetic energy into capacitor (H). Then the non-linear coil saturates between points (b) and (c) where again the coil has a small slope and the coil resistance switches to a low value. Capacitor (D) then dumps its charge (I) through coil (G) producing a large voltage spike in the input and output winding of transformer toroidal coil (J). The magnetic flux in coil (J) then produces a voltage spike in coils (L) and (M) of the magnetic vortex generator. The frequency of oscillation of the generator is determined by capacitor (K) and the overall inductance of the two coils. The diagram shows that the winding is non-linear and in opposite directions going from outer coil to the inner coil.

22. Frequency of oscillation has to be kept under 20 MHz in order to create a soft wormhole that connects to low pressure regions of hyperspace. The pressure regions of hyperspace are similar to the pressure produced by a dam holding water. The upper surface of the water, where there is no water pressure, is analogous to the black void into which our universe is expanding. In the middle of the dam, there is a region just above us having a lower water pressure which corresponds to the low density hyperspace energy. This analogy is not perfect because the many frequencies of hyperspace are quantized, as we know from quantum physics, rather than being a continuous spectrum of lower and lower frequencies down to the zero frequency of the black void.

What I claim as my invention is

1. A magnetic vortex generator which can generate negative mass according to Einstein's General Theory of Relativity, which is a tested and proven theory. As a result of this theory, it can be shown that negative mass is required to create a stable wormhole between space and hyperspace. Without the negative mass, the throat would close.

2. The generator consists of two solenoids wound with a common wire in opposite directions on two separate toroidal curved-sheet transformer laminates of differing radii. The smaller solenoid is mounted along the centerline of the larger solenoid.

3. According to Maxwell's equations, said geometrical and magnetic arrangement produces linear bucking electric fields along the centerline of said coils. Since curvature and the square of the electromagnetic fields are one and the same phenomenon according to Einstein's spacetime curvature tensor G=8π T, this resonance of the electric fields causes a resonance of the spacetime curvature and the opening of the wormhole.

4. Due to the fact that the magnetic flux travels within the laminations at a curvature equal to the inverse of the radius squared, each coil produces a spring constant which depends on the current, lamination area, magnetic field strength and the individual curvature of each coil.

5. Due to the fact that the flux travels in opposite directions in each solenoid, the spring constant of the outer coil is positive, and the spring constant of the inner coil is negative. These two spring constants, one positive and one negative, add in parallel to create a negative spring constant for the generator. Because the frequency of resonance is equal to the square root of the negative spring constant divided by the negative mass, the resonant frequency is positive real.

6. This process of creating and keeping open the wormhole allows low density hyperspace energy to enter our dimension. Because the linear mass is lower, Planck's constant, equal to the Planck mass times the Planck wavelength times the speed of light, is reduced to such an extent that the electron is moved out of dimension. Because the electron and proton are one and the same particle, when considering a path through space and hyperspace, the proton is also moved out of dimension. Thus this process of moving the atom in and out of dimension using the magnetic vortex generator has the ability to create cold-welded crystals, new types of materials and new ways to cold solder one disparate material to another.

7. As a consequence of said process, highly relativistic electromagnetic fields can be created because the velocity of light has been reduced considerably. These fields than can be used to produce life in the new class of electromagnetic propulsion vehicles.

8. As a consequence of said process, refrigeration systems can be created because negative energy cools rather than heats.

9. As a consequence of said process, power supplies can be made such that a differential spacetime curvature on the ends of a carbon electrode can create a differential voltage similar to a regular chemical battery.

10. As a consequence of this process, surgery-less medical tables can be fabricated whereby tumors can be pulled directly from the patient's body.

11. As a consequence of this process, the negative mass produced by the generator can offset the mass of a spacecraft to create a mass-less, inertia-less vehicle which can accelerate at hundreds of thousands of g's.

12. As a consequence of this process, the folding space waveguide becomes a reality whereby hyperspace energy, which has a low spring constant, can be easily folded and curved using powerful, relativistic electromagnetic fields. Spacecraft will be able to teleport themselves out-of-dimension over huge distances measured in terms of light-years.

13. Because the wormhole opens up an interdimensional connection to hyperspace having a magnetic monopole, a radial magnetic field is created. As a consequence of this process, a changing magnetic monopole field crossed with a changing electric field can produce a toroidal electromagnetic flux around the circular hull of the spacecraft. As a consequence of the merger of these two fields, a spacetime curvature G_{zz} is produced over the hull of the spacecraft which creates a tension or lift force which enables the spacecraft to ascend, hover or descend.

14. An electrical system, comprised of a variable frequency generator and amplifier, an isolation transformer and voltage step-up transformer, drives a non-linear inductance which switches on and off the current in the output circuit in such a manner as to produce large voltage spikes through magnetic vortex generator. The generator responds by producing two large negative mass spikes close to the centerline of the two coils.

15. The winding on each coil of the generator has a non-linear spacing to enhance the magnetic field and to reduce the interwinding coil capacitance.

16. The ratio of the radius of the small coil to that of the larger coil is 1/3, which is the magic ratio in physics. This creates a spring constant that is proportional to 8/9. The square of the cosine of the tetrahedral angle of 19.47° is equal to this ratio. Also the ratio of the area-to-volume ratio of the circumscribing sphere of a tetrahedron to the area-to-volume ratio of the tetrahedron is also 1/3. And the corners of the tetrahedron touch the circumscribing sphere at 19.47°. All the large volcanoes and vortices on Earth, Mars, Jupiter, Uranus and Neptune are located at this latitude. Thus this invention is more effective in developing a wormhole because it is tuned geometrically to the tetrahedral geometry of space.
